(19) United States
(12) Patent Application Publication
(10) Pub. No.: US 2025/0381907 A1
(43) Pub. Date: Dec. 18, 2025

(54) VEHICULAR HEADLAMP

(71) Applicant: KOITO MANUFACTURING CO., LTD., Tokyo (JP)

(72) Inventor: Hidetada TANAKA, Shizuoka-shi, Shizuoka (JP)

(73) Assignee: KOITO MANUFACTURING CO., LTD., Tokyo (JP)

(21) Appl. No.: 18/878,221

(22) PCT Filed: Aug. 7, 2023
(86) PCT No.: PCT/JP2023/028685

§ 371 Date: Dec. 23, 2024

(30) Foreign Application Priority Data
Aug. 8, 2022 (JP) 2022-126620

(51) Int. Cl. B60Q 1/14

(52) U.S. Cl. CPC B60Q 1/1423; B60Q 2300/056; B60Q 2300/41

(57) ABSTRACT

A vehicular headlamp (1) includes a plurality of light emitting elements (33) and a control unit (CO), in which the control unit (CO) attenuates, when an object is located in front of a host vehicle (100), a light amount of light emitted from one part of light emitting units, which are the light emitting elements (33d) to (33g) each irradiating a first region (91) with light having a higher light intensity than that of a region other than the first region (91), and a light amount of light emitted from another part of the light emitting units, which are the light emitting elements (33c) and (33h) each irradiating a second region (92) with light having a higher light intensity than that of a region other than the second region (92), as compared with a case where an object is not located in front of the host vehicle (100).

### TECHNICAL FIELD

The present invention relates to a vehicular headlamp.

### BACKGROUND ART

There is known a vehicular headlamp that emits light in a light distribution pattern including a light shielding region in which light is not emitted because the light overlaps another vehicle located in front of a host vehicle. Patent Literature 1 below discloses such a vehicular headlamp. In the vehicular headlamp, when the host vehicle is separated from the other vehicle and a left-and-right width of the light shielding region is smaller than a threshold value, a light intensity of light in a region around the light shielding region is higher than a light intensity when a high beam is lit. As a result, even when the host vehicle is away from the other vehicle, an end portion of the light shielding region is emphasized by light increase, and the periphery of the light shielding region becomes bright.

[Patent Literature 1] JP 2018-172038 A

### Summary of Invention

A predetermined region adjacent to a dark region such as the light shielding region of the vehicular headlamp of Patent Literature 1 is irradiated with light from a light emitting element different from a light emitting element that irradiates the dark region with light. In general, light from another light emitting element includes light that irradiates a predetermined region and light that irradiates a region other than the predetermined region and has a lower light intensity than that of the light that irradiates the predetermined region. The light having the lower light intensity tends to irradiate a dark region adjacent to a predetermined region, and there is a demand for improvement in suppression of glare given to a driver of the other vehicle in the dark region where the other vehicle as a predetermined object overlaps. Examples of the predetermined object include, in addition to the other vehicle, a retroreflective object that retroreflects emitted light, such as a pedestrian or a road sign, and here as well, it is required to improve suppression of glare given to a pedestrian or a driver of a host vehicle irradiated with light reflected by the retroreflective object.

Therefore, an object of the present invention is to provide a vehicular headlamp capable of improving suppression of glare when light of a light distribution pattern including a dark region is emitted.

To achieve the above object, a vehicular headlamp according to the present invention includes: a plurality of light emitting units, each of the light emitting units emitting light to a front side of a host vehicle at a predetermined divergence angle to form a light distribution pattern of the light; and a control unit configured to receive a signal from a detection device that detects a predetermined object located in front of the host vehicle, the control unit being configured to control the plurality of light emitting units, in which the control unit is configured, in a case where the predetermined object is located in front of the host vehicle, to attenuate, in comparison with a case where the predetermined object is not located in front of the host vehicle, a light amount of the light emitted from one part of the light emitting units each irradiating a first region with light having a higher light intensity than a light intensity of a region other than the first region, in which the first region overlaps at least a part of the predetermined object in the light distribution pattern, and a light amount of the light emitted from another part of the light emitting units each irradiating a second region with light having a higher light intensity than a light intensity of a region other than the second region, in which the second region is located adjacent to the first region and does not overlap the predetermined object.

In the vehicular headlamp, when the predetermined object is located in front of the host vehicle, as compared with a case where the predetermined object is not located in front of the host vehicle, the light amount of light emitted from each of the one part of the light emitting units and the other part of the light emitting units is attenuated. As the light amount of the light emitted from the one part of the light emitting units decreases, the first region becomes dark. In addition, the light emitted from the other part of the light emitting units includes light that irradiates the second region and light that irradiates the region other than the second region and has a lower light intensity than that of the light that irradiates the second region. The light having the lower light intensity tends to irradiate the first region adjacent to the second region. In the vehicular headlamp, when the light amount of the light emitted from the other part of the light emitting units decreases, the light amount of light having a lower light intensity and irradiating the first region among the lights emitted from the other part of the light emitting units also decreases, and the first region becomes darker. Therefore, as compared with a case where the light amount of the light emitted from the other part of the light emitting units does not decrease, the first region becomes dark, and suppression of glare can be improved.

The control unit may be configured, in a case where the predetermined object is located in front of the host vehicle, to simultaneously attenuate the light amount of the light emitted from the one part of the light emitting units and the light amount of the light emitted from the other part of the light emitting units.

According to the configuration, the burden on the control unit can be reduced as compared with a case where the control unit does not simultaneously attenuate the light amount of the light emitted from the one part of the light emitting units and the light amount of the light emitted from the other part of the light emitting units.

Alternatively, the control unit may be configured, when the predetermined object is located in front of the host vehicle, to attenuate the light amount of the light emitted from the one part of the light emitting units earlier than attenuating the light amount of the light emitted from the other part of the light emitting units.

When the light amount of the light emitted from the one part of the light emitting units each irradiating the first region is attenuated later than the light amount of the light emitted from the other part of the light emitting units each irradiating the second region, the second region that does not overlap the object becomes dark earlier than the first region, and the driver of the host vehicle may feel discomfort. However, according to the configuration, it is possible to prevent the driver of the host vehicle from feeling such discomfort.

Further, a straight line passing through a center of the host vehicle in a leftward-and-rightward direction of the host vehicle and extending in a forward-and-rearward direction of the host vehicle may pass through the first region.

As described above, according to the present invention, it is possible to provide a vehicular headlamp capable of improving suppression of glare when light of a light distribution pattern including a dark region is emitted.

### BRIEF DESCRIPTION OF DRAWINGS

FIG. 1 is a plan view conceptually illustrating a vehicle including a vehicular headlamp according to an embodiment of the present invention.

FIG. 2 is a front view schematically illustrating a second light source unit.

FIG. 3 is a control flowchart of a control unit according to the embodiment.

FIG. 4 is a view illustrating an example of a light distribution pattern of a high beam according to the embodiment.

FIG. 5 is a view illustrating an example of an ADB light distribution pattern in a case where a host vehicle and another vehicle are traveling on a straight track, the view being illustrated similarly to FIG. 4.

FIG. 6 is a view illustrating an example of an ADB light distribution pattern in a case where a host vehicle and another vehicle are traveling on a left curve, the view being illustrated similarly to FIG. 4.

FIG. 7 is a view illustrating an example of an ADB light distribution pattern in a case where a host vehicle and another vehicle are traveling on a left curve and the other vehicle approaches the center of left and right sides of the host vehicle as compared to FIG. 6, the view being illustrated similarly to FIG. 4.

### DESCRIPTION OF EMBODIMENTS

Hereinafter, embodiments for implementing a vehicular headlamp according to the present invention will be described with reference to the accompanying drawings. The embodiments exemplified below are intended to facilitate understanding of the present invention and are not intended to limit the present invention. The present invention can be modified and improved without departing from the gist thereof. Note that, in the drawings referred to below, dimensions of each member may be changed for easy understanding.

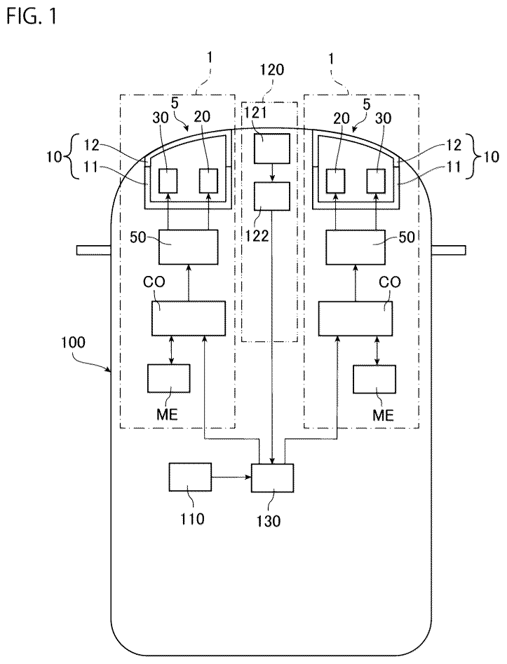

FIG. 1 is a conceptual view illustrating a vehicle including a vehicular headlamp according to an embodiment. As illustrated in FIG. 1, a host vehicle 100 includes a pair of left and right vehicular headlamps 1, a light switch 110, a detection device 120, and an electronic control unit (ECU) 130. In the present specification, “right” means the right side in a forward direction of the host vehicle 100, “left” means the left side in the forward direction, and a driver means a driver of the host vehicle 100. The host vehicle 100 of the present embodiment is an automobile.

Each vehicular headlamp 1 includes a lamp part 5, a memory ME, a control unit CO, and a power supply circuit 50. In general, the lamp part 5 of one vehicular headlamp 1 is disposed on the left side of a front portion of the host vehicle 100, and the lamp part 5 of the other vehicular headlamp 1 is disposed on the right side of the front portion. The configuration of one vehicular headlamp 1 is the same as the configuration of the other vehicular headlamp 1 except that the shapes of the lamp substantially symmetrical to each other. Therefore, one vehicular headlamp 1 will be described below, and the description of the other vehicular headlamp 1 will be omitted.

The lamp part 5 includes a housing 10, a lamp unit 20 for a light distribution pattern of a low beam, and a lamp unit 30 for an additional light distribution pattern that is added to the light distribution pattern of the low beam to form a light distribution pattern of a high beam. The light distribution pattern means both a shape of an image of light formed on a virtual vertical screen, for example, 25 m ahead of the host vehicle 100 and an intensity distribution of light in the image.

The housing 10 includes a housing 11 and a front cover 12. The housing 11 is formed in a box shape having an opening on the front side thereof, and the front cover 12 is fixed to the housing 11 to close the opening. Accordingly, a housing space surrounded by the housing 11 and the front cover 12 is formed in the housing 10, and the lamp units 20 and 30 are disposed in the housing space. The front cover 12 allows light emitted from each of the lamp units 20 and 30 to be transmitted therethrough. The power supply circuit 50, the control unit CO, and the memory ME are disposed outside the housing 10, but may be disposed in the housing space of the housing 10.

The lamp unit 20 emits light forming the light distribution pattern of the low beam to the front side of the host vehicle 100. The lamp unit 20 includes a first light source unit, a shade, and a first projection lens.

The first light source unit includes a light emitting element serving as a light emitting unit that emits light forward, and a circuit board on which the light emitting element is mounted. In the present embodiment, the light emitting element is a light emitting diode (LED). The shade is provided between the light emitting element and the first projection lens, and shields a part of the light emitted from the light emitting element such that the light emitted from the light emitting element forms the light distribution pattern of the low beam. The first projection lens adjusts a divergence angle of light incident from the light emitting element without being shielded by the shade. The light, the divergence angle of which is adjusted by the first projection lens, is emitted from the front cover 12 to the front side of the host vehicle 100.

The lamp unit 30 emits light forming the additional light distribution pattern to the front side of the host vehicle 100. The lamp unit 30 includes a second light source unit and a second projection lens disposed in front of the second light source unit.

The second projection lens adjusts a divergence angle of light incident from the second light source unit. The light, the divergence angle of which is adjusted by the second projection lens, is emitted from the front cover 12 to the front side of the host vehicle 100.

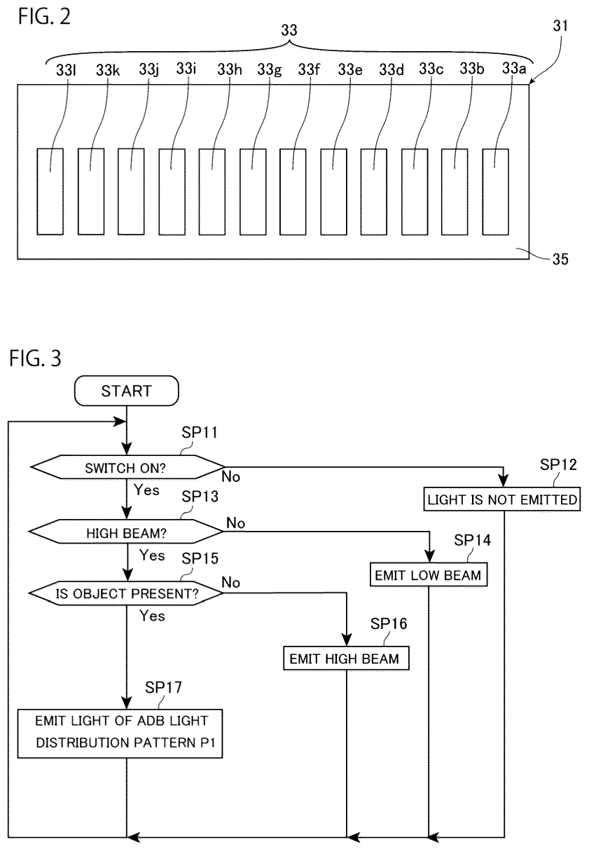

FIG. 2 is a front view schematically illustrating the second light source unit of the lamp unit 30. A second light source unit 31 of the present embodiment includes a plurality of light emitting elements 33a to 33l each serving as a light emitting unit that emits light forward, and a circuit board 35 on which the plurality of light emitting elements 33a to 33l are mounted. Hereinafter, the light emitting elements 33a to 331 may be collectively referred to as a light emitting element 33. The respective light emitting elements 33 are arranged in one row in a leftward-and-rightward direction in an array shape, and each of emission surfaces thereof has a substantially rectangular shape longer in an upward-and-downward direction. The light emitting elements 33 can individually change a light amount of light to be emitted. In the present embodiment, the light emitting elements 33 are LEDs, and the second light source unit 31 is a so-called LED array. In FIG. 2, the number of the light emitting elements 33 arranged in the leftward-and-rightward direction is 12, but the number is not particularly limited.

The memory ME illustrated in FIG. 1 is configured to be able to store information and read the stored information. The memory ME is, for example, a non-transitory recording medium, and is preferably a semiconductor recording medium such as a random access memory (RAM) or a read only memory (ROM), but can include a recording medium of any format such as an optical recording medium or a magnetic recording medium. Note that the “non-transitory” recording medium includes all computer-readable recording media except for a transitory propagating signal, and does not exclude a volatile recording medium. Various programs for control of the lamp units 20 and 30 and information necessary for the control are stored in the memory ME, and the control unit CO reads the programs and the information stored in the memory ME. Note that the memory ME may be provided inside the control unit CO.

The control unit CO includes, for example, an integrated circuit such as a microcontroller, an integrated circuit (IC), a large-scale integrated circuit (LSI), or an application specific integrated circuit (ASIC), or a numerical control (NC) device. Furthermore, in a case where the NC device is used, the control unit CO may use a machine learning device or may not use a machine learning device. The control unit CO is electrically connected to the ECU 130, and in the respective vehicular headlamps 1, the control units CO are electrically connected to each other via the ECU 130. The control unit CO receives a signal from the detection device 120 via the ECU 130. Note that the control units CO may be electrically directly connected to each other without involving the ECU 130.

The power supply circuit 50 includes a driver, and when a control signal is input from the control unit CO, power supplied from a power supply (not illustrated) to each of the light emitting elements respectively provided in the first light source unit and the second light source unit 31 is adjusted by the driver. Accordingly, the light amount of light emitted from each of the light emitting elements is adjusted, light of the light distribution pattern of the low beam is emitted from the lamp unit 20, and light of the light distribution pattern of the high beam or light of a light distribution pattern of an adaptive driving beam (ADB) is emitted from the lamp units 20 and 30. The ADB light distribution pattern is a light distribution pattern in which partial regions in the light distribution pattern of the high beam are first and second regions in which the light amount is reduced. Furthermore, in the present embodiment, the driver of the power supply circuit 50 adjusts the power supplied to each of the light emitting elements by pulse width modulation (PWM) control, thereby adjusting the amount of light emission of each of the light emitting elements. However, a method of adjusting the light amount of light emitted from each of the light emitting elements is not particularly limited.

The light switch 110 of the present embodiment is a switch that selects emission or non-emission of light. In addition, the light switch 110 selects emission of low beam light or high beam light in emission of light. The light switch 110 outputs a signal indicating emission of the selected light to the control unit CO via the ECU 130 in an ON state, and does not output the signal in an OFF state.

The detection device 120 of the present embodiment detects a predetermined object located in front of the host vehicle 100. Examples of the object include other vehicles such as a preceding vehicle and an oncoming vehicle, retroreflective objects, and humans such as pedestrians. The retroreflective object of the present embodiment is an object that does not emit light by itself and retroreflects emitted light at a predetermined spreading angle. Examples of such a retroreflective object include a road sign, a visual guidance sign, and the like. The detection device 120 of the present embodiment includes an image acquisition unit 121 and a detection unit 122.

The image acquisition unit 121 acquires an image of the front side of the host vehicle 100, in which the image includes at least a part of a region that can be irradiated with light emitted from the pair of vehicular headlamps 1. Examples of the image acquisition unit 121 include a charged coupled device (CCD) camera, a complementary metal oxide semiconductor (CMOS) camera, light detection and ranging (LiDAR), a millimeter wave radar, and the like. The image acquisition unit 121 outputs a signal related to the acquired image to the detection unit 122.

The detection unit 122 has, for example, a configuration similar to that of the control unit CO. The detection unit 122 performs predetermined image processing on the image acquired by the image acquisition unit 121, and detects the presence of an object, the present position of the object in the image, the type of the object, and the like from the image subjected to the image processing.

When the object is detected from the image, the detection unit 122 outputs a signal indicating information related to the object to the control unit CO via the ECU 130. The information related to the object includes the presence of the object, the present position of the object in the image, the type of the object, and the like. In addition, when the object is not detected, the detection unit 122 outputs a signal indicating that the object does not exist to the control unit CO via the ECU 130, and may not output the signal.

Note that the object detected by the detection device 120, the number of types of objects, and the configuration of the detection device 120 are not particularly limited. For example, the image acquisition unit 121 may be a CCD camera or LiDAR, and here, the detection unit 122 detects an object based on an image acquired by the CCD camera and the LiDAR.

Next, the operation of the vehicular headlamp 1 of the present embodiment will be described. In the present embodiment, the operations of the pair of vehicular headlamps 1 are the same and synchronized with each other. Therefore, hereinafter, the operation of one vehicular headlamp 1 will be described, and the description of the operation of the other vehicular headlamp 1 will be omitted.

FIG. 3 is a control flowchart of the control unit CO according to the embodiment. As illustrated in FIG. 3, a control flow includes steps SP11 to SP17. In a starting state illustrated in FIG. 3, it is assumed that the image acquisition unit 121 of the detection device 120 acquires an image of the front side of the host vehicle 100, and a signal transmitted from the detection unit 122 is input to the control unit CO.

### Step SP11

In the present step, when a signal from the light switch 110 is not input, the control unit CO advances the control flow to step SP12, and when the signal is input, the control unit CO advances the control flow to step SP13.

### Step SP12

In the present step, the control unit CO controls the power supply circuit 50 not to emit light from the lamp units 20 and 30. Thus, the vehicular headlamp 1 does not emit light. Then, the control unit CO returns the control flow to step SP11.

### Step SP13

In the present step, when a signal related to the emission of the low beam light is input from the light switch 110, the control unit CO advances the control flow to step SP14. In addition, when a signal related to the emission of the high beam light is input from the light switch 110, the control unit CO advances the control flow to step SP15.

### Step SP14

In the current step, the control unit CO controls the lamp unit 20 to emit the low beam from the vehicular headlamp 1. Specifically, the control unit CO controls the power supply circuit 50 to supply power to the light emitting element of the first light source unit. Due to the supply of power, light of the light distribution pattern of the low beam is emitted from the vehicular headlamp 1. Accordingly, the low beam is emitted from the vehicular headlamp 1. When the low beam is emitted from the vehicular headlamp 1, the control unit CO returns the control flow to step SP11.

### Step SP15

In the current step, when a signal indicating that an object does not exist is input from the detection unit 122, the control unit CO advances the control flow to step SP16, and when a signal indicating information related to the object is input from the detection unit 122, the control unit CO advances the control flow to step SP17.

### Step SP16

In the current step, the control unit CO controls the lamp units 20 and 30 to emit the high beam from the vehicular headlamp 1. Specifically, the control unit CO controls the power supply circuit 50 to supply power to all light emitting elements 33 of the first light source unit and the second light source unit 31. Due to the supply of power, light of the light distribution pattern of the high beam is emitted from the vehicular headlamp 1. Accordingly, when an object does not exist, the high beam is emitted from the vehicular headlamp 1.

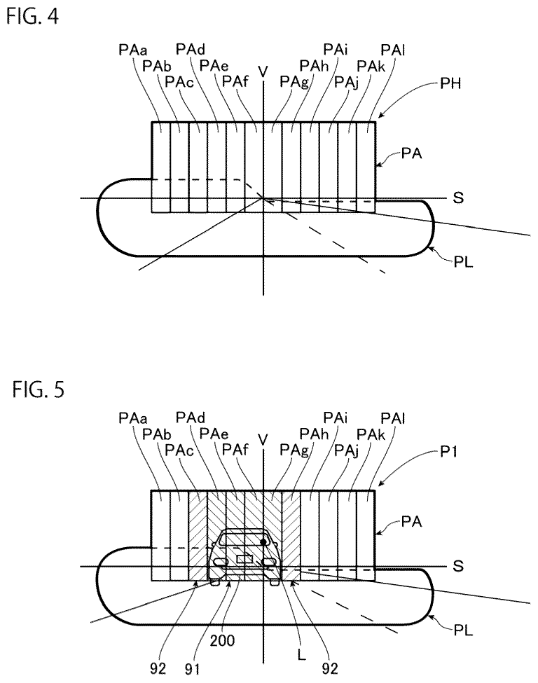

FIG. 4 is a view illustrating an example of the light distribution pattern of the high beam according to the present embodiment. In FIG. 4, S indicates a horizontal line, V indicates a vertical line passing through the center of the host vehicle 1 100 in the leftward-and-rightward direction, and a high beam light distribution pattern PH formed on a virtual vertical screen disposed 25 m ahead of the host vehicle 100 is indicated by a thick line. The high beam light distribution pattern PH is formed by adding a substantially horizontally long rectangular additional light distribution pattern PA to a low beam light distribution pattern PL. A part of the additional light distribution pattern PA overlaps the low beam light distribution pattern PL, and the additional light distribution pattern PA extends in the horizontal direction and overlaps the horizontal line S. In FIG. 4, a portion overlapping the additional light distribution pattern PA in a cut-off line which is an upper edge of the low beam light distribution pattern PL is indicated by a broken line.

The additional light distribution pattern PA is formed by partial light distribution patterns PAa to PAl, and each of the partial light distribution patterns PAa to PAl is formed by light emitted from the respective light emitting elements 33a to 33l. Since the light emitting elements 33a to 33l are arranged in one row in the leftward-and-rightward direction, the partial light distribution patterns PAa to PAl are also arranged in one row in the leftward-and-rightward direction. The partial light distribution pattern PAf and the partial light distribution pattern PAg are in contact with the vertical line V. Among the partial light distribution patterns PAa to PAl, patterns adjacent to each other are in contact with each other. Positions, orientations, and the like of the light emitting elements 33a to 33l are adjusted to arrange the partial light distribution patterns PAa to PAl as described above. The partial light distribution patterns PAa to PAl respectively correspond to shapes of emission surfaces of the light emitting elements 33a to 33l, and have substantially the same size and rectangular shapes longer in the upward-and-downward direction. The size and shape of the additional light distribution pattern PA are changed depending on the selection of the light emitting elements 33a to 33l that emit light. In addition, an intensity distribution of light in the additional light distribution pattern PA is adjusted by adjusting the amount of light emission of each of the light emitting elements 33a to 33l.

A certain partial light distribution pattern is irradiated with light having a predetermined light intensity from a certain light emitting element. In addition, it does not mean that the outside of a certain partial light distribution pattern completely avoids light from a certain light emitting element that irradiates the certain partial light distribution pattern, and light having a lower light intensity than a light intensity of the light that irradiates the certain partial light distribution pattern is emitted by the certain light emitting element. In the following description, light that is emitted from a light emitting element corresponding to a certain partial light distribution pattern, irradiates the outside of the certain partial light distribution pattern, that is, a region other than the certain partial light distribution pattern, and has a lower light intensity than a light intensity of light that irradiates the partial light distribution pattern by the light emitting element may be referred to as leakage light. A light intensity of light from a certain light emitting element that irradiates a certain partial light distribution pattern is higher than a light intensity of leakage light from the certain light emitting element that irradiates a region other than the certain partial light distribution pattern. In addition, leakage light from a certain light emitting element that irradiates a certain partial light distribution pattern also irradiates a partial light distribution pattern adjacent to the certain partial light distribution pattern. Therefore, even when a light emitting element corresponding to a certain partial light distribution pattern is turned off, when a light emitting element corresponding to an adjacent partial light distribution pattern is turned on, the certain partial light distribution pattern is irradiated with leakage light that has a certain degree of illuminance and is emitted from a certain light emitting element that irradiates the adjacent partial light distribution pattern.

Note that some of the adjacent partial light distribution patterns may overlap each other. Alternatively, the adjacent partial light distribution patterns may be separated from each other and form gaps therebetween. However, the partial light distribution patterns PAa to PAl are preferably arranged without gaps therebetween in the leftward-and-rightward direction. The sizes and shapes of the partial light distribution patterns PAa to PAl are not particularly limited, and may be different from each other.

In the present embodiment, when the high beam is emitted from the vehicular headlamp 1, the control unit CO returns the control flow to step SP11.

### Step SP17

In the present step, the control unit CO controls the lamp units 20 and 30 such that the light distribution pattern of the light emitted from the vehicular headlamp 1 becomes an ADB light distribution pattern corresponding to an object located in front of the host vehicle 100, in which the object is detected by the detection device 120.

FIG. 5 is a view illustrating an example of the ADB light distribution pattern in the present embodiment, the view being illustrated similarly to FIG. 4. An ADB light distribution pattern P1 is a light distribution pattern in which a first region 91 and a second region 92 are formed in the high beam light distribution pattern PH. FIG. 5 illustrates an example in which an object is another vehicle 200, and the other vehicle 200 overlaps a part of the partial light distribution patterns PAd to PAg in the additional light distribution pattern PA and a part of the low beam light distribution pattern PL. In FIG. 5, a case where the host vehicle 100 and the other vehicle 200 travel on a straight track will be described as an example.

The first region 91 is an entire region of the light distribution patterns overlapping the other vehicle 200 among the partial light distribution patterns PAa to PAl of the additional light distribution pattern PA. In FIG. 5, as described above, the other vehicle 200 overlaps the partial light distribution patterns PAd to PAg in the additional light distribution pattern PA. Therefore, an entire region of the partial light distribution patterns PAd to PAg is the first region 91. A straight line L passing through a center of the host vehicle 100 in the leftward-and-rightward direction of the host vehicle 100 and extending in the forward-and-rearward direction of the host vehicle 100 passes through the first region 91 of the present embodiment. The straight line L is orthogonal to the vertical line V. In the present step, a light amount of such a first region 91 is smaller than a light amount of a region corresponding to the first region 91 in the high beam light distribution pattern PH. As a result, the first region 91 becomes dark. In FIG. 5, the state of light reduction of the first region 91 is indicated by hatching with oblique lines. According to the vehicular headlamp 1 of the present embodiment, the amount of light emitted to the other vehicle 200 can be reduced to suppress glare given to a driver of the other vehicle 200. Note that, from the viewpoint of suppressing glare given to the driver of other vehicle 200, the first region 91 may overlap at least a part of a visual recognition portion configured to enable the driver of the other vehicle 200 to visually recognize the outside of the vehicle. Note that the visual recognition portion is, for example, a front window when the other vehicle 200 is an oncoming vehicle. In addition, when the other vehicle 200 is a preceding vehicle, the visual recognition portion is, for example, a side mirror, a rear window, an imaging device that images the rear side of the vehicle, and the like, and the visual recognition portion tends to be generally disposed above the license plate.

Such a first region 91 may be any region in the additional light distribution pattern PA in the high beam light distribution pattern PH, in which the region overlaps at least a part of the object and the light amount decreases as compared with a case where an object is not located in front of the host vehicle 100. That is, the light amount of the first region 91 may be any value smaller than the light amount of the region corresponding to the first region 91 in the high beam light distribution pattern PH. Meanwhile, each of the partial light distribution patterns PAd to PAg, which are the first region 91, is irradiated with light having a higher light intensity than that of a region other than the partial light distribution patterns PAd to PAg, in which the light is emitted from each of the light emitting elements 33d to 33g. To darken the first region 91 as described above, in the present step, when an object is located in front of the host vehicle 100, the control unit CO attenuates the light amount of light emitted from the light emitting elements 33d to 33g that irradiate the first region 91 overlapping at least a part of the object with light having a higher light intensity than that of a region other than the first region 91, as compared with a case where an object is not located in front of the host vehicle 100.

Among the partial light distribution patterns PAa to PAl of the additional light distribution pattern PA, the second region 92 is an entire region of the light distribution patterns that are located adjacent to the first region 91 and does not overlap the other vehicle 200 which is an object. In the present embodiment, since the first region 91 is the partial light distribution patterns PAd to PAg, each of the partial light distribution patterns PAc and PAh is the second region 92. A light amount of the second region 92 is smaller than a light amount of a region corresponding to the second region 92 in the high beam light distribution pattern PH. As a result, the second region 92 becomes dark. Meanwhile, each of the partial light distribution patterns PAc and PAh is irradiated with light having a higher light intensity than that of a region other than the partial light distribution patterns PAc and PAh which are the second region 92, in which the light is emitted from each of the light emitting elements 33c and 33h. As described above, to darken the second region 92, in the present step, when an object is located in front of the host vehicle 100, the control unit CO attenuates the light amount of light emitted from the light emitting elements 33c and 33h that irradiate the second region 92, which is located adjacent to the first region 91 and does not overlap the object, with light having a higher light intensity than that of a region other than the second region 92, as compared with a case where an object is not located in front of the host vehicle 100. In FIG. 5, the state of light reduction of the partial light distribution patterns PAc and PAh is indicated by hatching with oblique lines. Note that the direction of the oblique lines is changed to make it easy to see a difference from the state of light reduction of the partial light distribution patterns PAd to PAg.

Meanwhile, leakage light from the light emitting element 33c that irradiates the partial light distribution pattern PAc also irradiates the partial light distribution patterns PAb and PAd adjacent to the partial light distribution pattern PAc. In addition, leakage light from the light emitting element 33h that irradiates the partial light distribution pattern PAh also irradiates the partial light distribution patterns PAg and PAi adjacent to the partial light distribution pattern PAh. When the light amount of light emitted from the light emitting elements 33c and 33h is attenuated as described above, leakage light emitted from the light emitting elements 33c and 33h is also attenuated, such that the partial light distribution patterns PAb, PAd, PAg, and PAi become dark. When the partial light distribution patterns PAd and PAg become dark, the first region 91 becomes dark.

In the present step, when a predetermined object is located in front of the host vehicle 100, the control unit CO simultaneously attenuates the light amount of light emitted from one part of the light emitting units, which are the light emitting elements 33d to 33g, and the light amount of light emitted from another part of the light emitting units, which are the light emitting elements 33c and 33h.

According to the configuration, the burden on the control unit CO can be reduced as compared with a case where the control unit CO does not simultaneously attenuate the light amount of light emitted from the one part of the light emitting units and the light amount of light emitted from the other part of the light emitting units. Furthermore, according to the configuration, for example, as compared with a case where the light amount of the light emitted from the one part of the light emitting units each irradiating the first region 91 is attenuated later than the light amount of the light emitted from the other part of the light emitting units each irradiating the second region 92, a period until the light amount of the light emitted from the one part of the light emitting units is attenuated, during which the first region 91 is not in a predetermined darkness, is eliminated, thereby making it possible to suppress the driver of the host vehicle 100 from feeling discomfort.

Note that, as described above, the control unit CO does not need to simultaneously attenuate the light amount of the light emitted from the one part of the light emitting units, which are the light emitting elements 33d to 33g, and the light amount of the light emitted from the other part of the light emitting units, which are the light emitting elements 33c and 33h. For example, the control unit CO may attenuate the light amount of the light emitted from the one part of the light emitting units, which are the light emitting elements 33d to 33g, earlier than the light amount of the light emitted from the other part of the light emitting units, which are the light emitting elements 33c and 33h. When the light amount of the light emitted from the one part of the light emitting units each irradiating the first region 91 is attenuated later than the light amount of the light emitted from the other part of the light emitting units each irradiating the second region 92, the second region 92 that does not overlap the object becomes dark earlier than the first region 91, and the driver of the host vehicle 100 may feel discomfort. However, according to the configuration, it is possible to prevent the driver of the host vehicle 100 from feeling such discomfort. For example, the control unit CO may attenuate the light amount of the light emitted from the one part of the light emitting units, which are the light emitting elements 33d to 33g, later than the light amount of the light emitted from the other part of the light emitting units, which are the light emitting elements 33c and 33h.

In the present step, the first region 91 has the same brightness as the second region 92, and the first region 91 and the second region 92 have the same light amount per unit area. In the example illustrated in FIG. 5, the area of the first region 91 is larger than the area of the second region 92. Then, when a predetermined object is located in front of the host vehicle 100, the control unit CO attenuates the light amount of the light emitted from the one part of the light emitting units, which are the light emitting elements 33d to 33g, more than the light amount of the light emitted from the other part of the light emitting units, which are the light emitting elements 33c and 33h. Note that the first region 91 may be darker than the second region 92. The control unit CO may attenuate the light amount of the light emitted from the one part of the light emitting units by the same amount as the light amount of the light emitted from the other part of the light emitting units. In addition, the control unit CO may increase the light amount of light emitted from the light emitting element 33b that irradiates the partial light distribution pattern PAb, which is a third region on the opposite side to the first region 91 of the partial light distribution pattern PAc, which is the second region 92. When the light amount of the light emitted from the light emitting element 33b is increased, leakage light from the light emitting element 33b is also increased, such that the partial light distribution pattern PAa and the partial light distribution pattern PAc, which is the second region 92, become bright. Therefore, a decrease in brightness of the second region 92 due to attenuation of the light amount of the light emitted from the light emitting element 33c can be suppressed. Note that the control unit CO may increase the light amount of light emitted from the light emitting element 33i to brighten the partial light distribution pattern PAh, which is the second region 92. As a result, a decrease in brightness of the second region 92 due to attenuation of the light amount of the light emitted from the light emitting element 33h can be suppressed. In addition, when a predetermined object is located in front of the host vehicle 100, the control unit CO may simultaneously attenuate the light amount of the light emitted from the one part of the light emitting units, which are the light emitting elements 33d to 33g, the light amount of the light emitted from the other part of the light emitting units, which are the light emitting elements 33c and 33h, and the light amount of the light emitted from still another part of the light emitting units, which are the light emitting elements 33b and 33i. Alternatively, when a predetermined object is located in front of the host vehicle 100, the control unit CO may attenuate the light amount of the light emitted from each of the light emitting elements in the order of the light emitting elements 33d to 33g, then the light emitting elements 33c and 33h, and finally the light emitting elements 33b and 33i. Note that a light attenuation timing of the light emitting elements is not particularly limited.

When the light amount of the light emitted from the light emitting elements 33c to 33h is attenuated, the light of the ADB light distribution pattern P1 is emitted from the vehicular headlamp 1. Then, the control unit CO returns the control flow to step SP11.

As described above, in the present embodiment, as described in step SP17, when an object is located in front of the host vehicle 100, the control unit CO attenuates the light amount of the light emitted from the one part of the light emitting units, which are the light emitting elements 33d to 33g each irradiating the first region 91 with light having a higher light intensity than that of a region other than the first region 91, and the light amount of the light emitted from the other part of the light emitting units, which are the light emitting elements 33c and 33h each irradiating the second region 92 with light having a higher light intensity than that of a region other than the second region 92, as compared with a case where an object is not located in front of the host vehicle 100.

In the vehicular headlamp 1, when a predetermined object such as the other vehicle 200 is located in front of the host vehicle 100, the light amount of the light emitted from the one part of light emitting units, which are the light emitting elements 33d to 33g, and the light amount of the light emitted from the other part of the light emitting units, which are the light emitting elements 33c and 33h, are attenuated, as compared with a case where a predetermined object is not located in front of the host vehicle 100. As the light amount of the light emitted from the one part of the light emitting units decreases, the t first region 91 becomes dark. In addition, light having a lower light intensity than that of the light irradiating the second region 92 from among the lights emitted from the other part of the light emitting units irradiates the first region 91 adjacent to the second region 92. In the vehicular headlamp, when the light amount of the light emitted from the other part of the light emitting units decreases, the light amount of light having a lower light intensity and irradiating the first region 91 among the lights emitted from the other part of the light emitting units also decreases, and the first region 91 becomes darker. Therefore, as compared with a case where the light amount of the light emitted from the other part of the light emitting units does not decrease, the first region 91 becomes dark, and the suppression of glare given to the driver of the other vehicle 200, which is an object, can be improved. In the above-described embodiment, the object has been described as the other vehicle 200, but the operation of the vehicular headlamp 1 is the same as that in the embodiment even when the object is a pedestrian or a retroreflective object. In the present embodiment, when the object is a pedestrian, the suppression of glare given to the pedestrian can be improved, and when the object is a retroreflective object, the suppression of glare given to the driver of the host vehicle 100 irradiated with light reflected by the retroreflective object can be improved.

Although the present invention has been described by taking the above-described embodiment as an example, the present invention is not limited thereto.

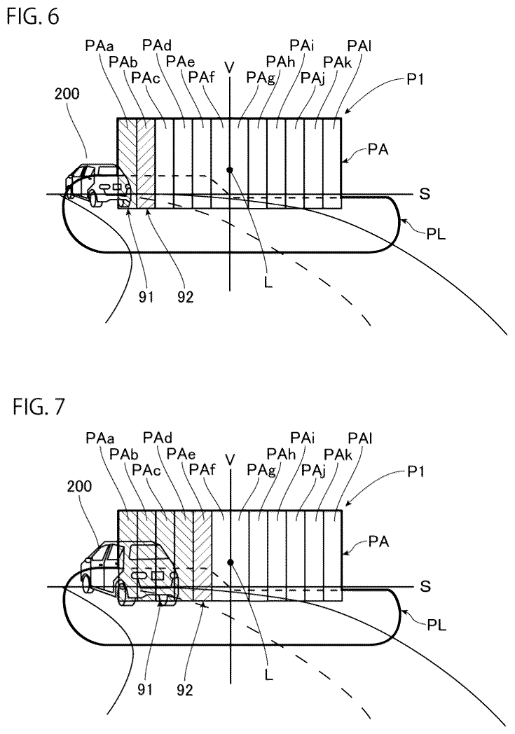

In the above embodiment, the first region 91 is set to the partial light distribution patterns PAd to PAg, and the second region 92 is set to the partial light distribution patterns PAc and PAh, but the first region 91 and the second region 92 vary depending on the position of the object in the additional light distribution pattern PA, and are not limited to the partial light distribution patterns. Although the first region 91 is set to a region through which the straight line L passes, the first region 91 may be a region through which the straight line L does not pass. FIG. 6 is a view illustrating an example of the ADB light distribution pattern P1 in a case where the host vehicle 100 and the other vehicle 200 travel on a left curve, the view being illustrated similarly to FIG. 4. FIG. 6 illustrates an example in which the other vehicle 200 overlaps a part of the partial light distribution pattern PAa in the additional light distribution pattern PA and a part of the low beam light distribution pattern PL. Here, the entire region of the partial light distribution pattern PAa is the first region 91, and the partial light distribution pattern PAb is the second region 92. In the ADB light distribution pattern P1 illustrated in FIG. 6, the first region 91 is a region through which the straight line L does not pass.

FIG. 7 is a view illustrating an example of the ADB light distribution pattern P1 in a case where the host vehicle 100 and the other vehicle 200 travel on a left curve and the other vehicle 200 approaches the center of left and right sides of the host vehicle 100 as compared to FIG. 6, the view being illustrated similarly to FIG. 4. A situation in which the other vehicle 200 illustrated in FIG. 7 approaches the center of the left and right sides of the host vehicle 100 will be described by taking a case where an inter-vehicle distance between the other vehicle 200 and the host vehicle 100 is shorter than that in FIG. 6 as an example. Note that the situation in which the other vehicle 200 approaches the center of the left and right sides of the host vehicle 100 includes, for example, a case where the host vehicle 100 and the other vehicle 200 have shifted from a situation of traveling on a curve to a situation of traveling on a straight track. FIG. 7 illustrates an example in which the other vehicle 200 overlaps a part of the partial light distribution patterns PAa to PAd in the additional light distribution pattern PA and a part of the low beam light distribution pattern PL. Here, the entire region of the partial light distribution patterns PAa to PAd is the first region 91, and the partial light distribution pattern PAe is the second region 92. When the traveling situation of the host vehicle 100 and the other vehicle 200 changes from the situation illustrated in FIG. 7 to the situation of traveling on a straight track, the ADB light distribution pattern P1 becomes the ADB light distribution pattern P1 illustrated in FIG. 5.

For example, when an image in which a pair of white light spots and a pair of red light spots each having higher luminance than predetermined luminance exist with a predetermined interval therebetween in the leftward-and-rightward direction is input from the image acquisition unit 121, the detection unit 122 may detect the presence of the other vehicle 200. For example, when an image in which the above pair of white light spots exist is input from the image acquisition unit 121, the detection unit 122 identifies the other vehicle 200 as an oncoming vehicle. When an image in which the above pair of red light spots exist is input from the image acquisition unit 121, the detection unit 122 identifies the other vehicle 200 as a preceding vehicle. For example, a pair of white light spots is a headlamp of an oncoming vehicle, and a pair of red light spots is a tail light of a preceding vehicle. Note that a method of detecting or identifying an oncoming vehicle and a preceding vehicle is not particularly limited.

In the ADB light distribution pattern P1 illustrated in FIG. 5, when light spots of the other vehicle 200, such as a pair of white or red light spots, exist in an image input from the image acquisition unit 121, the control unit CO may attenuate the light amount of light emitted from the light emitting elements 33d to 33g, each of which irradiates the first region 91 where the light spots and a region between the light spots overlap each other with light having a higher light intensity than that of a region other than the first region 91, and the light amount of light emitted from the light emitting elements 33c and 33h, each of which irradiates the second region 92 with light having a higher light intensity than that of a region other than the second region 92, as compared with a case where light spots are not located. Therefore, it can be understood that the control unit CO attenuates the light amount of the light emitted from the light emitting elements 33c to 33h depending on the presence or absence of light spots of a self-luminous object. Examples of such a self-luminous object include, in addition to the light spots of the other vehicle 200, a flashlight that emits light toward the host vehicle 100, and the like. By using a flashlight, it is possible to realize an experiment for detecting attenuation of a light amount of light emitted from a light emitting element. Note that a method of detecting whether the light amount of light emitted from the light emitting element is attenuated is not limited thereto.

In the above embodiment, the second region 92 is set to the partial light distribution patterns PAc and PAh respectively adjacent to the left side and the right side of the first region 91, but the second region 92 may be set to a light distribution pattern adjacent to the left side of the first region 91 or a light distribution pattern adjacent to the right side of the first region 91.

Furthermore, in the above-described embodiment, the second light source unit 31 including the plurality of light emitting elements 33 capable of individually changing the light amount of light to be emitted has been described as an example. However, the second light source unit 31 is not limited. For example, the second light source unit 31 may include a digital mirror device (DMD) including a plurality of reflective elements arranged in an array shape and a light emitting unit that irradiates the DMD with light. The DMD can adjust the light amount of light emitted in a predetermined direction from a reflecting surface of each of the reflective elements, and can emit light in a predetermined direction from each of the reflective elements. Here, it can be understood that the DMD corresponds to a light emitting unit capable of individually changing the light amount of light emitted by the reflecting surface of each of the reflective elements. Note that the first light source unit may also include a DMD and a light emitting unit.

In the above embodiment, as an example, a description has been given as to the host vehicle 100 including the pair of vehicular headlamps 1 each including the control unit CO and the memory ME. However, at least one of the control unit CO and the memory ME may be shared by the pair of vehicular headlamps 1. In addition, the signal output from the detection device 120 may be input to the control unit CO without involving the ECU 130. In addition, the vehicle provided with the vehicular headlamp 1, the number of vehicular headlamps 1 provided in the vehicle, and the like are not particularly limited.

According to the present invention, a vehicular headlamp capable of improving suppression of glare when light of a light distribution pattern including a darkening region is emitted is provided, and the vehicular headlamp can be used in the field of vehicular headlamps of automobiles and the like.

1. A vehicular headlamp comprising:
a plurality of light emitting units, each of the light emitting units emitting light to a front side of a host vehicle at a predetermined divergence angle to form a light distribution pattern of the light; and
a control unit configured to receive a signal from a detection device that detects a predetermined object located in front of the host vehicle, the control unit being configured to control the plurality of light emitting units,
wherein the control unit is configured, in a case where the predetermined object is located in front of the host vehicle, to attenuate, in comparison with a case where the predetermined object is not located in front of the host vehicle, a light amount of the light emitted from one part of the light emitting units each irradiating a first region with light having a higher light intensity than a light intensity of a region other than the first region, in which the first region overlaps at least a part of the predetermined object in the light distribution pattern, and a light amount of the light emitted from another part of the light emitting units each irradiating a second region with light having a higher light intensity than a light intensity of a region other than the second region, in which the second region is located adjacent to the first region and does not overlap the predetermined object.

2. The vehicular headlamp according to claim 1, wherein
the control unit is configured, in a case where the predetermined object is located in front of the host vehicle, to simultaneously attenuate the light amount of the light emitted from the one part of the light emitting units and the light amount of the light emitted from the other part of the light emitting units.

3. The vehicular headlamp according to claim 1, wherein
the control unit is configured, in a case where the predetermined object is located in front of the host vehicle, to attenuate the light amount of the light emitted from the one part of the light emitting units earlier than the light amount of the light emitted from the other part of the light emitting units.

4. The vehicular headlamp according to claim 1, wherein
a straight line passing therethrough a center of the host vehicle in a leftward-and-rightward direction of the host vehicle and extending in a forward-and-rearward direction of the host vehicle passes through the first region.
